(19) United States
(12) Patent Application Publication
(10) Pub. No.: US 2002/0184097 A1
(43) Pub. Date: Dec. 5, 2002

(54) Advertisement distributing device and charging device

(76) Inventors: Toshiki Hijiri, Hirakata-shi (JP); Yoshiyuki Mochizuki, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/132,415

(22) Filed: Apr. 26, 2002

(30) Foreign Application Priority Data
May 31, 2001 (JP) 2001-163822

(51) Int. Cl. G06F 17/60

(52) U.S. Cl. 705/14

(57) ABSTRACT

An advertisement-added content distributing device 10 includes a database 181, an advertisement selecting unit 131, and a content distributing unit 132. The database 181 includes a plurality of advertisements, and the ad selecting unit 131 selects at least one advertisement from the advertisements in the database 181. The content distributing unit 132 distributes the selected advertisement together with a requested content to a member viewer terminal device 20 used by a viewer who has made a request for distribution of the content.

### BACKGROUND OF THE INVENTION

(1) Field of the Invention

The present invention relates to an advertisement distributing device included in a system for distributing digital contents and advertisements via a communication network such as the Internet, and also relates to a charging device used in such distribution.

(2) Description of Related Art

Under a business model that is becoming increasingly common, a digital content distributor distributes digital contents together with advertisements and charges advertisers for the distributed advertisements.

With a conventional technique using this business model, a communication program for automatic reception function is installed in users' personal computers (PCs) so that the PCs automatically access a server of a content distributor at a predetermined time to receive the latest advertisement (see, as one example, Japanese Laid-Open Patent Application No. 2000-89708, “Advertising System Using the Internet”).

This conventional technique aims to increase effectiveness of advertisements by having users access the server without requiring their voluntary actions.

With this conventional technique, however, the same advertisements are indiscriminately distributed to all the users, which include those who are not targeted by advertisers, and therefore some advertisements are needlessly distributed.

With another conventional technique, viewers receive a plurality of advertisements in a digital broadcast, and advertisements to display are selected from the received advertisements in accordance with property information on each viewer (see, as one example, Japanese Laid-Open Paten Application No. H11-17633, “Advertisement Broadcast Method”). In this way, this technique increases advertising effectiveness by selectively displaying advertisements in accordance with properties of each viewer.

For this broadcast system, too, however, the same advertisements are indiscriminately distributed from a broadcast station to viewers although the distributed advertisements are selectively displayed.

When transmission amount (band) required for the above conventional techniques is considered, such conventional techniques cannot always achieve highly efficient advertising and results in having advertisers incur high advertising cost.

### SUMMARY OF THE INVENTION

The present invention is made in view of the above problems, and aims, as the first object, to provide an advertisement distributing device capable of selectively distributing advertisements considered to exert a high advertising effect while avoiding distribution of unnecessary advertisements that wouldn't be viewed by viewers.

The first object can be achieved by an advertisement distributing device that distributes an advertisement and a content via a communication network to a terminal device used by a user who makes a request for distribution of the content. The advertisement distributing device includes: an advertisement storing unit operable to store a plurality of advertisements; an advertisement selecting unit operable to select at least one advertisement from the plurality of advertisements in the advertisement storing unit in accordance with the request; and a distributing unit operable to distribute the at least one selected advertisement together with the requested content to the terminal device.

In more detail, the advertisement selecting unit selects the advertisement in accordance with either the requested content, a property of the viewer (such as his age, address, and type in content types), a time at which the request was received, or any combination of these. This is to say, in accordance with each content distribution request from a viewer, the advertisement selecting unit selects an advertisement that is likely to interest the viewer, and distributes the selected advertisement together with the requested content.

As the above advertisement distributing device avoids indiscriminate distribution of the same advertisement to all the viewers, it can increase cost-effectiveness in advertisement distribution.

More specifically, the advertisement selecting unit may select the advertisement in accordance with a content ID (identification) of the requested content.

With this construction, an advertisement related to the requested content, for instance, is distributed, so that the viewer who requested the content is more likely to view the distributed advertisement.

Here, the advertisement selecting unit may select the advertisement in accordance with a property of the user who has made the request. More specifically, the property of the viewer may be the viewer's age, address, and preference in content types. This construction selectively distributes advertisements considered to interest a certain age group, advertisements that only target viewers living in a certain region, and advertisements that suit preference of each viewer, so that advertisements are more likely to be viewed and used by viewers.

Here, the advertisement selecting unit may select the advertisement in accordance with a time at which the request has been received.

This construction makes it possible to control content distribution such as by distributing certain advertisements that target late-night viewers or by distributing advertisements targeting adults in a predetermined time slot.

Here, the advertisement distributing device may further include: a user information storing unit operable to store user information consisting of (a) user IDs of users and (b) a preference of each of the users in content types, with each user ID associated with a preference; an advertisement information storing unit operable to store advertisement information that consists of (a) advertisement IDs of the advertisements stored in the advertisement storing unit and (b) an age, an address, and a preference of target users for each of the stored advertisements, with each advertisement ID associated with an age, an address and a preference of target users for an advertisement identified by the advertisement ID; and a user ID specifying unit operable to specify a user ID of the user when the request is received. The advertisement selecting unit may (a) refer to the user information to find an age, an address, and a preference associated with the specified user ID, (b) refer to the advertisement information to find an advertisement ID associated with the found age, address, and preference, and (c) select the advertisement identified by the found advertisement ID.

With this construction, advertisements considered to interest the viewer are selected based on not a single information item contained in the content distribution request but comprehensively on a plurality of information items. Accordingly, the advertiser's intention can be more precisely reflected in selection of advertisements for distribution.

The present invention also aims, as the second object, to provide a charging unit that is used by the above advertisement distributing device and that is capable of charging an advertisement-placement fee reasonable for advertisers.

The second object can be achieved by a charging device that is included in the above advertisement distributing device and that determines a fee charged to an advertiser for advertisement placement. This charging device includes a determining unit operable to determine the fee for the advertisement placement in accordance with information based on which the above advertisement selecting unit selects each advertisement. Alternatively, the above determining unit may determine the fee in accordance with a size or a display position of each advertisement displayed by the terminal device of the user.

In this way, the fee for advertisement placement is determined in accordance with the advertisement selecting processing or a display form of the advertisement.

Unlike a method for charging fees for indiscriminately distributed advertisement, the above construction charges a fee for advertisements considered to exert a higher advertising effect. Consequently, the above charging device can increase the cost-effectiveness, and therefore allows a reasonable fee to be charged for advertisement placement to advertisers.

Here, the above charging device may include a determining unit operable to determine the fee for the advertisement placement in accordance with a number of times a same content as the requested content has been requested.

With this construction, a high fee can be set, for instance, for an advertisement to be distributed together with a popular content that has been distributed many number of times. This achieves charging based on actual distribution times of the contents.

Here, the above charging device may include a determining unit operable to determine the fee for the advertisement placement in accordance with a size and a display position of the advertisement displayed by the terminal device of the user.

For this construction, a fee for advertisement placement is determined based on a degree of attraction of the advertisement displayed by the user's terminal device. This can achieve a reasonable charging system based on advertising effectiveness.

The present invention can be also embodied as an advertisement distributing method and a charging method that include steps of the processing of the above advertisement distributing device and the charging unit, respectively. It is also possible to embody the present invention as a program to have a computer perform the above processing. Such program may be recorded on a computer-readable recording medium, such as a CD-ROM (compact disc read-only memory). The present invention also may be embodied as a system for distributing a content and an advertisement via a communication network, or as a viewer's terminal device for making a request to the advertisement distributing device for content distribution in such system.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the construction of an advertisement-added content distributing system 1 according to one embodiment of the present invention;

FIG. 2 is a block diagram showing detailed functions of an ad-added content distributing device 10 shown in FIG. 1;

FIG. 3 shows the example construction of a content property table 162 shown in FIG. 2;

FIG. 4 shows the example construction of a member information table 171 shown in FIG. 2;

FIG. 5 shows the example construction of a member preference table 172 shown in FIG. 2;

FIG. 6 shows the example construction of an advertisement property table 182 shown in FIG. 2;

FIGS. 7A and 7B show example screens based on an item of designated display position/size/form in the ad property table 182 shown in FIG. 6;

FIG. 8 shows the example construction of an advertisement distribution history table 183 shown in FIG. 2;

FIG. 9 is a flowchart showing the processing of a content processing unit 130 shown in FIG. 2; and

FIG. 10 is a sequence diagram showing communication between an ad-added content distributing device 10, a member viewer terminal device 20, and an advertiser terminal device 30 that make up the ad-added content distributing system 1.

### DESCRIPTION OF THE PREFERRED EMBODIMENT

The following specifically describes the present invention based on several embodiments and drawings.

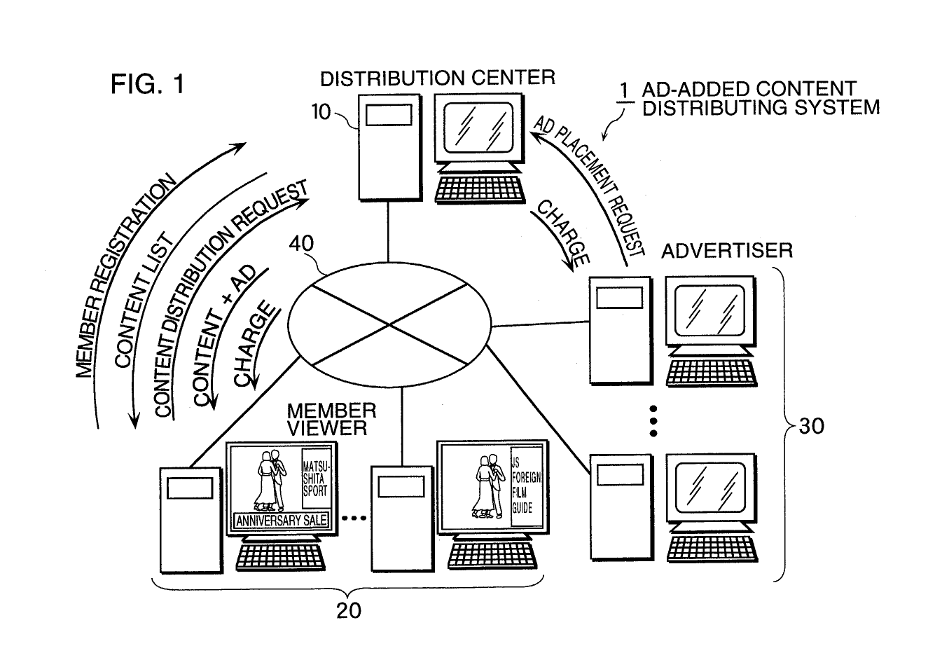

FIG. 1 is a general view of an advertisement-added content distributing system 1.

This content distributing system 1 distributes digital contents as streams, such as films, in accordance with requests from member viewers registered in advance. The content distributing system 1 is characteristic in that it selects an advertisement to be added to a digital content in accordance with a variety of parameters indicated by each request, and distributes the ad-added content. The content distributing system 1 comprises three types of devices 10, 20, and 30 that are connected to one another via a communication network 40 such as the Internet. The ad-added content distributing device 10 is used at a content distribution center, and the member viewer terminal devices 20 are used by member viewers of ad-added contents. The advertiser terminal devices 30 are used by advertisers who place ads to be multiplexed into contents.

The content distributing device 10 is a distribution server used at the content distribution center for providing distribution service of contents and advertisements. The content distributing device 10 is a device such as a computer, which selects a certain content and advertisement from stored contents and advertisements in accordance with a request from each member viewer, and multiplexes the selected content and advertisement into an MPEG (Moving Picture Experts Group) stream to distribute to the member viewer.

The content distributing device 10 also functions as a WWW (world wide web) server that manages Web pages for dialog between member viewers and advertisers. As indicated by “Charge” in FIG. 1, the content distributing device 10 charges viewers for content distribution, and advertisers for advertisements multiplexed in contents. These charges are used to pay the royalty of copyrighted contents and manage the content distribution center.

The member viewer terminal devices 20 are PCs or the like used by member viewers for viewing contents. Software installed in the viewer terminal devices 20 includes the following: a reproduction program for receiving and reproducing the MPEG stream; an Web browser for having the terminal devices 20 as WWW clients access the content distributing device 10 to make the membership registration, obtain a content list, and select a desired content from the content list; and an electronic mail (e-mail) software application.

The advertiser terminal devices 30 are PCs or the like used by advertisers of advertisements multiplexed into contents to distribute to viewers. Software installed in each advertiser terminal device 30 includes an Web browser and an e-mail software application for communicating as an WWW client with the stated content distribution center.

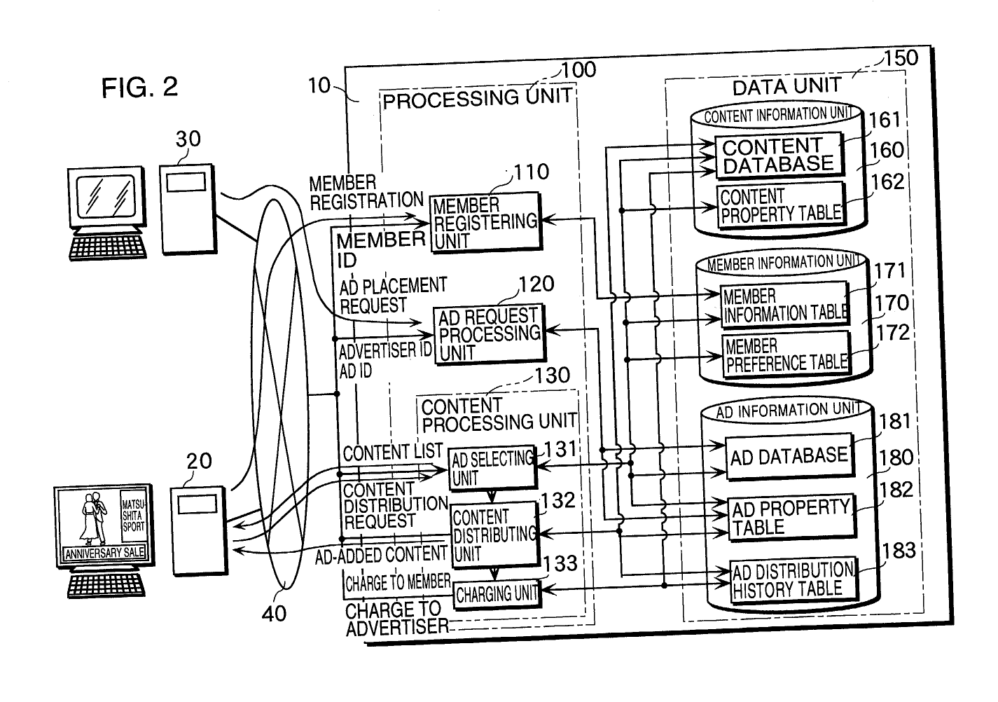

FIG. 2 is a block diagram showing the detailed construction of the content distributing device 10 and how (and what kind of) information is transferred among the content distributing device 10, the viewer terminal devices 20, and the advertiser terminal devices 30.

The content distributing device 10 is roughly divided into two units: a data unit 150 that is achieved by hard disks storing data files; and a processing unit 100 achieved by scripts and programs written on the Web pages.

The data unit 150 includes a content information unit 160 storing information relating to contents, a member information unit 170 for storing information relating to membership of viewers, and an advertisement information unit 180 storing information relating to advertisements requested by advertisers. The content information unit 160 contains a content database 161 and a content property table 162. The member information unit 170 contains a member information table 171 and a member preference table 172. The ad information unit 180 contains an advertisement database 181, an advertisement property table 182, and an advertisement distribution history table 183.

The processing unit 100 includes a member registering unit 110 for registering a viewer as a member of the content distributing system 1, an advertisement request processing unit 120 for processing an advertisement request from advertisers, and a content processing unit 130 for distributing ad-added contents to member viewers. This content processing unit 130 contains an advertisement selecting unit 131, a content distributing unit 132, and a charging unit 133.

The content database 161 includes contents to be distributed by the content distributing device 10, and the contents' names and IDs (identifiers) associated with the contents.

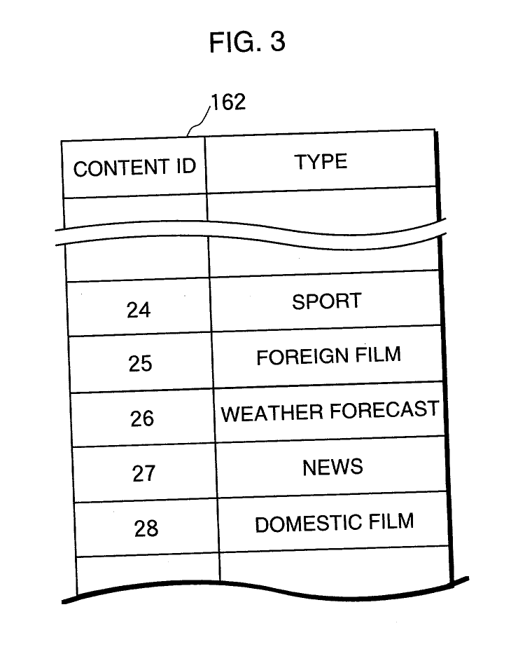

The content property table 162 contains properties of the contents stored in the content database 161. As shown in FIG. 3, the property table 162 associates an ID of each content with a type of the content, such as “Foreign Film”, “Domestic Film”, “News”, “Weather Forecast”, and “Sport.”

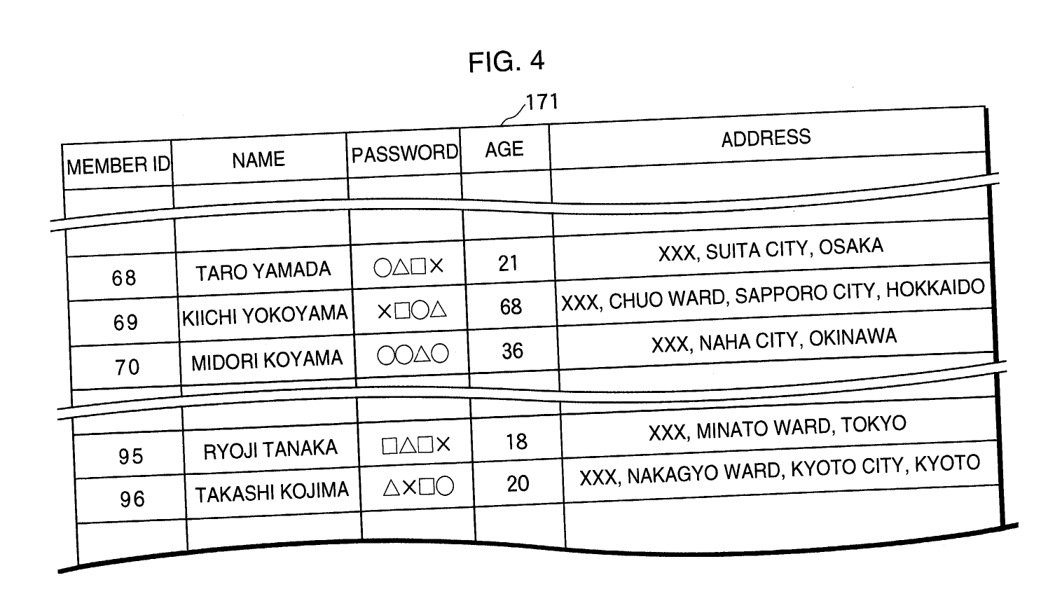

The member information table 171 is generated and updated by the member registering unit 110, and stores information sent by the member viewer terminal devices 20 when viewers enroll themselves as members of the content distributing system 1. More specifically, the member information table 171 contains, for each member viewer, his member ID, name, password, age, and address, as shown in FIG. 4.

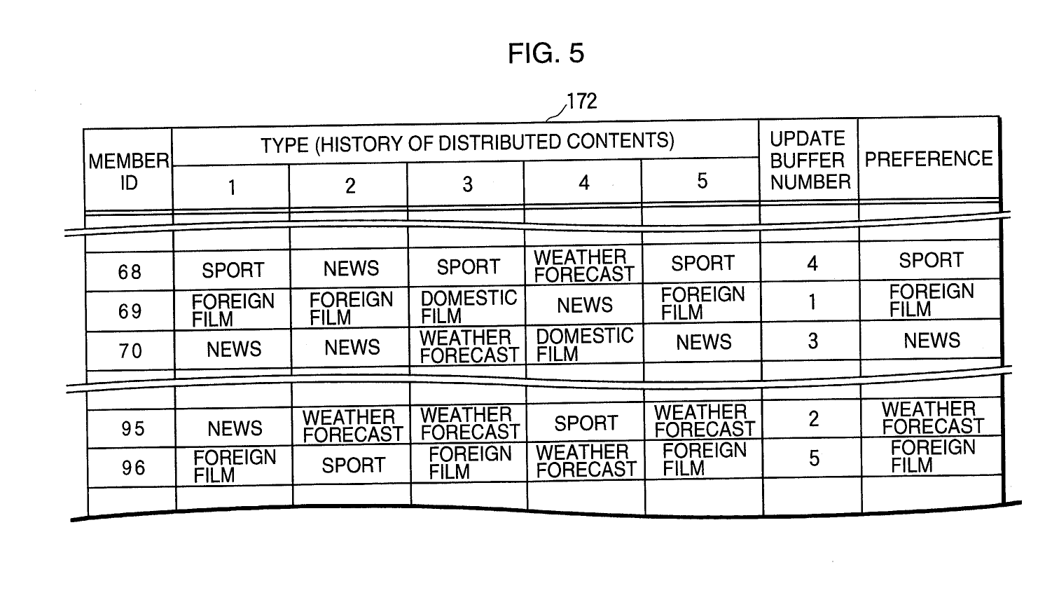

The member preference table 172 stores types of contents requested by each member viewer, and his preference in content types specified by history of his requests for the contents. As shown in FIG. 5, the member preference table 172 associates the following sets of data with one another for each member viewer: a member ID; types of five contents requested by the member most recently, which are stored in a ring buffer; an update buffer number indicating a buffer location storing a type of a content requested at the earliest time of all the five types stored in the ring buffer; and a preference represented by the most type of all the five types in the ring buffer.

The ad database 181 is generated and updated by the ad request processing unit 120, and associates each advertisement sent from each advertiser terminal device 30 with an advertisement ID to store them. In addition to advertisements, the ad database 181 also stores advertiser information relating to advertisers, such as names of the advertisers, their addresses, advertiser IDs, and Ids of requested advertisements.

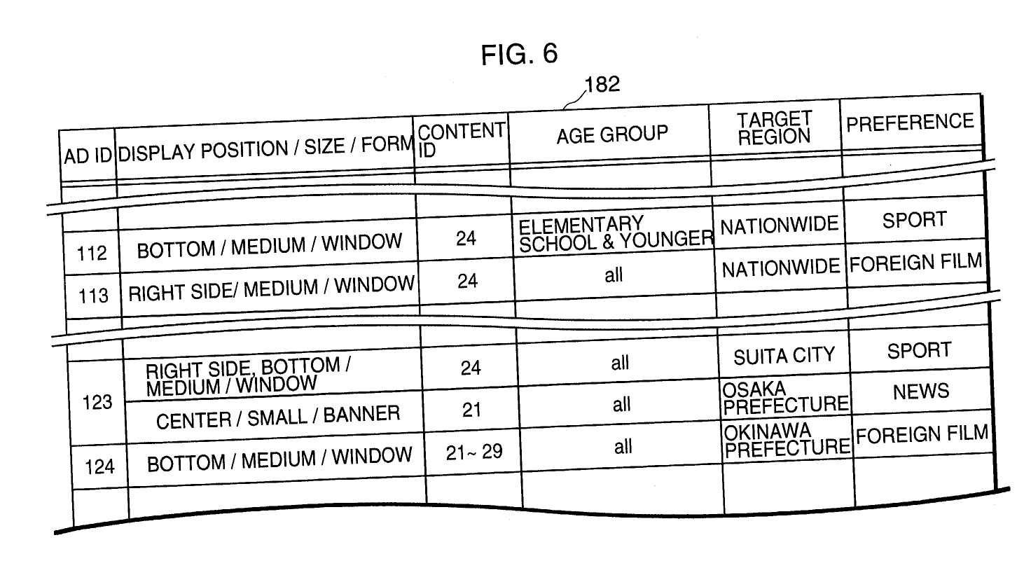

The ad property table 182 is generated by the ad request processing unit 120, and stores information which is given by each advertiser when making an advertisement placement request. This information specifies specific conditions that should be met for placing (multiplexing) an advertisement in a content, and display forms of the advertisement. In more detail, as shown in FIG. 6, the ad property table 182 stores the following items: an ID of an advertisement; a display position/size/form used by the viewer terminal devices 20 when displaying the advertisement; a content ID that specifies a content into which the advertisement is multiplexed; an age group of target viewers; a target region; and a preference of the target viewers.

Among the above items in the ad property table 182, the content ID, the age group, the target region, and the preference are used to select a certain advertisement to be multiplexed into a content (hereafter, these four items are called “ad selecting items”). This is to say, when a member viewer sends a content distribution request, an advertisement associated with the four ad selecting items that meet the sent content distribution request is selected, and multiplexed in a content to be distributed.

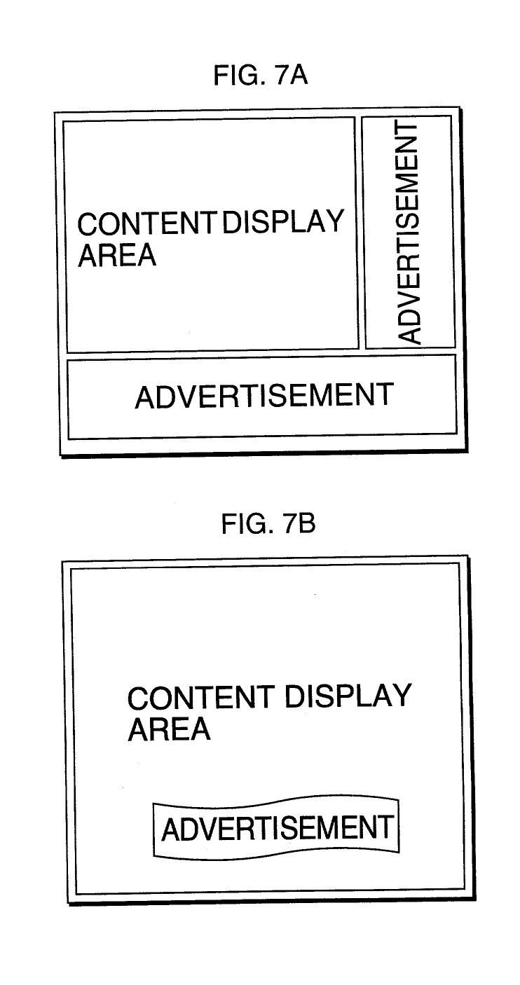

The display position/size/form item in the ad property table 182 designates display conditions used for each viewer terminal device 20 to display an advertisement as follows. The advertisement should be displayed, for instance, in the right or bottom part of a screen with the size being either large, medium, or small. The display form designates that the advertisement should be displayed as either a window (i.e., tiling display without the advertisement superimposed over the content) as shown in FIG. 7A, or a banner (with which the advertisement is superimposed over or embedded in the content) as shown in FIG. 7B.

On the other hand, items of the display position/size/form, content ID, age group, and target region in the ad property table 182 are used to determine a fee charged to an advertiser for an advertisement (hereafter, these four items are called “advertiser charging items”).

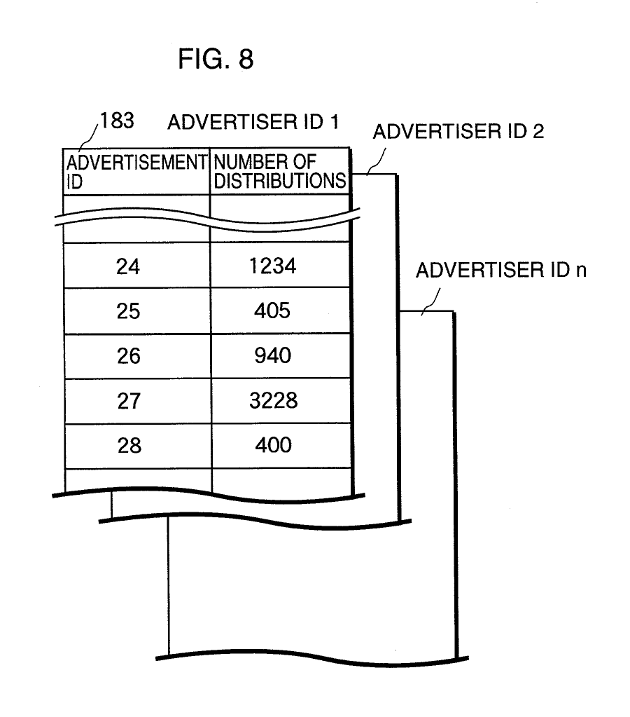

The ad distribution history table 183 is generated and updated by the content distributing unit 132 and is used to count the number of distribution times each advertisement sent by each advertiser has been distributed. More specifically, as shown in FIG. 8, the distribution history table 183 stores an advertisement ID and the number of distributions for an advertisement associated with the advertisement ID.

The member registering unit 110 receives a member registration request from each viewer terminal device 20, writes the content of the registration and the viewer's name, password, age, and address into the member information table 171, and issues a member ID to the viewer.

The ad request processing unit 120 receives an advertisement placement request from each advertiser terminal device 30, and writes the advertiser's name and address, and an advertisement for placement indicated by the placement request into the ad database 181. At the same time, the ad request processing unit 120 writes, into the ad property table 182, the ad selecting items and the advertiser charging items (i.e., display position/size/form, content ID, age group, target region, and preference) which are designated by the ad placement request. The ad request processing unit 120 then issues an advertiser ID and an advertisement ID for the advertisement to be placed to the advertiser terminal device 30. In accordance with the designated advertiser charging items, the ad request processing unit 120 then determines a fixed basic fee to be charged to the advertiser regardless of the number of distributions. The request processing unit 120 sends a bill for the determined basic fee by e-mail to the advertiser at the end of every month.

When viewer's access for viewing contents is detected, the ad selecting unit 131 sends a content list to the viewer. On receiving a content distribution request from the viewer, the ad selecting unit 131 refers to a content ID and a member ID contained in the received content distribution request, and searches the ad property table 182. The ad selecting unit 131 then reads, from the ad database 181, an advertisement specified by an advertisement ID that is designated by an advertiser for the requested content. The ad selecting unit 131 then sends the read advertisement and the content ID to the content distributing unit 132.

The content distributing unit 132 then reads a content specified by the sent content ID from the content database 161, multiplexes the sent advertisement and the read content into a stream, and distributes the stream of the ad-added content to the viewer terminal device 20 that made the content distribution request.

The charging unit 133 charges member viewers for distributed contents, and advertisers for advertisements on a pay-per-view basis. For the present embodiment, the same fee is charged to member viewers for every distributed content regardless of its type (e.g., ¥10 for one content distribution). Similarly, the fixed fee is charged to advertisers for every one advertisement distribution (e.g., ¥5 for one advertisement distribution) regardless of the stated basic fee. The charging unit 133 calculates a monthly fee charged to each advertiser by adding all the number of distributions associated with each advertisement ID indicated in the ad distribution history table 183 for the advertiser, and multiplies the total number of distributions by the fee of ¥5. The charging unit 133 then sends a bill for the calculated monthly fee by e-mail to each advertiser at the end of month.

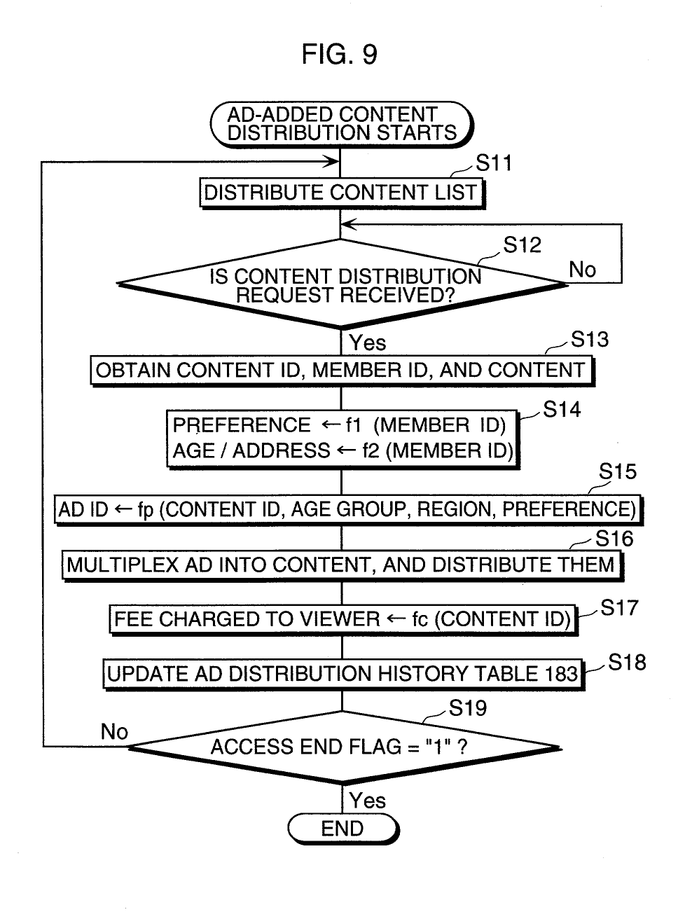

FIG. 9 is a flowchart showing distribution processing of the content processing unit 130.

When viewer's access for viewing contents is detected, the ad selecting unit 131 in the content processing unit 130 sends an Web page containing the content list to the viewer's terminal device 20 (step S11). The ad selecting unit 131 then waits for a content distribution request from this viewer terminal device 20 (step S12). This content list includes, for instance, the following information: content IDs that are arranged in accordance with types of contents and that have been obtained by searching the content database 161 and the content property table 162; content names placed next to the content IDs; and scripts associated with the content IDs for making a content distribution request. The viewer who receives this content list can make a content distribution request by only clicking on a part of a representation of a content ID of a desired content. Through this content distribution request, the viewer terminal device 20 sends not only the content ID of the desired content but also his member ID and password to the content distributing device 10.

On receiving the content distribution request from the viewer terminal device 20 (i.e., when “Yes” is selected in step S12), the ad selecting unit 131 recognizes that the viewer is a member of the content distributing system 1 by referring to the member ID and the password in the received content distribution request. The ad selecting unit 131 also specifies the content ID in the distribution request, and notifies the content distributing unit 132 of the specified content ID, so that the distributing unit 132 reads a content associated with the specified content ID from the content database 161 (step S13).

Following this, in accordance with the specified member ID, the ad selecting unit 131 specifies preference of the viewer by using the member preference table 172, and also specifies age and address of the viewer by using the member information table 171 (step S14). When specifying the preference of the viewer in step S14, the ad selecting unit 131 performs the following processing. The selecting unit 131 first specifies a type of a content associated with the content ID in the received content distribution request by referring to the content property table 162, and overwrites the specified type in a buffer indicated by the update buffer number in the member preference table 172. The ad selecting unit 131 then increments the update buffer number by one in a cyclic manner, specifies the most type of all the types written in the five buffers as the preference of the viewer, and updates the item of preference to the specified preference. Consequently, the preference of the viewer is updated to the latest one whenever the viewer makes a new content distribution request.

Following this, the ad selecting unit 131 searches the ad selecting items (i.e., content ID, age group, target region, and preference) in the ad property table 182 to specify an advertisement ID associated with ad selecting items that match the content ID, the viewer's age, address, and preference specified in step S14 (step S15). More specifically, the ad selecting unit 131 specifies records that contain the same content ID as the content distribution request, and further specifies, from these records, records that include an age group that matches the viewer's age. From these records, the ad selecting unit 131 specifies records that contain target regions that match the viewer's address, and specifies, from these records, records containing the same preference as the specified viewer's preference.

For instance, when a member viewer, Taro Yamada with a member ID “68” shown in FIG. 4, makes a distribution request for a sport content with a content ID “24”, the ad selecting unit 131 specifies this content ID, and his age, address and preference, which are “24”, “21”, “XXX, Suita City, Osaka”, and “Sport”, respectively. From the ad property table 182, the ad selecting unit 131 specifies records containing the content ID “24”, that is, the records containing advertisement IDs “112”, “113”, “123”, and “124”, from which the selecting unit 131 further specifies records containing the age group item that matches the viewer's age “21.” As a result, records with the advertisement IDs of “123” and “124” are specified. From these records, the selecting unit 131 further specifies a record with the advertisement ID “123” that contains the target region item matching “XXX, Suita City, Osaka” and recognizes that the specified record contains “sport” as the preference item. The selecting unit 131 then reads the advertisement associated with the advertisement ID “123” from the ad database 181. The read advertisement will be added to a content to be distributed and displayed, for instance, as “Matsushita Sport” and “Anniversary Sale” (see FIG. 1).

Similarly, when a member viewer, Takashi Kojima with a member ID “96” shown in FIG. 4, makes a distribution request for the same content with the content ID “24” as the above, the ad selecting unit 131 specifies this content ID, and his age “20”, address “XXX, Nakagyo Ward, Kyoto City, Kyoto”, and preference “Foreign Film.” The selecting unit 131 then searches the ad selecting items (i.e., content ID, age group, target region, and preference) one by one in the ad property table 182, and finds a record containing an advertisement ID “113.” The selecting unit 131 then reads an advertisement associated with the found advertisement ID “113”, which is then added to a content to be distributed, and displayed as “JS Foreign Film Guide” (see FIG. 1), for instance.

Accordingly, the same advertisement is not necessary distributed in response to distribution requests made for the same content because an advertisement is selected out of a plurality of advertisements in accordance with a plurality of sets of information constituting each content distribution request.

The ad selecting unit 131 not only reads the advertisement associated with the specified advertisement ID from the ad database 181 but also reads, from the ad property table 182, the item of display position/size/form associated with the specified advertisement ID. (Hereafter, the item of display position/size/form is called “display information.”) The ad selecting unit 131 then sends the content ID, the read advertisement, and the read display information to the content distributing unit 132.

The content distributing unit 132 divides the content read in step S13 into a plurality of content units that correspond to a certain reproduction duration, and multiplexes data of the sent advertisement into each content unit. The content distributing unit 132 then sends the ad-added content units as streams to the viewer terminal device 20 that made the content distribution request (step S16). It is alternatively possible to send the whole content first and then send the advertisement, instead of multiplexing the advertisement into the content.

On completion of the ad-added content distribution, the charging unit 133 receives the member ID and the advertisement ID from the content distributing unit 132, and charges the member viewer for the content (step S17). At the same time, the content distributing unit 133 increments the number of distributions in the ad distribution history table 183 by one to charge the advertiser (i.e., calculate a total of the number of distributions) (step S18).

The content processing unit 130 then judges whether an access end flag indicates “1” (step S19). This end flag indicates whether access is made to the content distributing device 10 for obtaining a content, and is set as “0” while the access is made. On the completion of the access, the flag is set as “1.” When judging that the flag indicates “0” (i.e., the “no” judgment is given in step S19), the ad selecting unit 131 sends the content list to the viewer terminal device 20 (step S11), and waits for the next content distribution request (step S12). When the access end flag indicates “1” (i.e., the “yes” judgment is given in step S19), the content processing unit 130 terminates the processing.

As a result, the above content distribution processing is terminated when content viewing has been completed and such as when the viewer terminal device 20 is offline. When the viewer wishes to continuously view another content, the content list is distributed, so that the viewer can obtain a desired content only by clicking on a content ID of the desired content.

The viewer terminal device 20 displays the ad-added content, as shown in FIGS. 7A and 7B. When the screen shown in FIG. 7A is displayed, the display information for the advertisement is represented, for instance, by coordinate data regarding positions of the content and the advertisement. When a displayed screen is as shown in FIG. 7B, the advertisement is embedded in the content together with (or in accordance with) the display information for the advertisement. This is possible by using object encoding technology according to MPEG4, for instance.

The following describes the overall processing of the ad-added content distributing system 1 that includes the stated units.

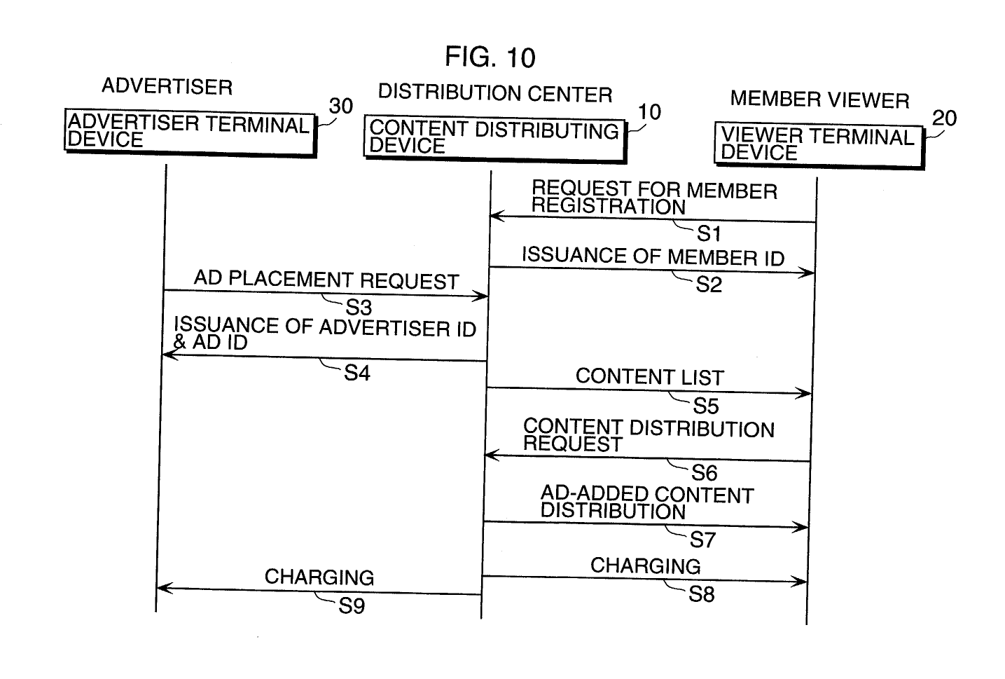

FIG. 10 is a sequence diagram showing communication between the advertiser terminal device 30, the ad-added content distributing device 10, and the member viewer terminal device 20.

On receiving a viewer's operation to enroll himself as a member of the system, the viewer terminal device 20 accesses the content distributing device 10 and sends member information composed of the viewer's name, password, age, and address (step S1). On receiving the member information, the content distributing device 10 registers it into the member information table 171, and issues a member ID to the viewer terminal device 20 (step S2). This notifies the viewer that he is registered as a member of the ad-added content distributing system 1 and that ad-added content distribution by the content distributing device 10 starts.

Through operations of an advertiser who wishes to make an ad placement request, the advertiser terminal device 30 accesses the content distributing device 10 and sends the ad placement request containing the following information: the advertiser's name and address; an advertisement to be placed; the display information for the advertisement; a content ID of a content in which the advertisement is multiplexed; an age group, a region, and preference of viewers the advertiser targets for the advertisement (step S3).

On receiving the ad placement request from the advertiser terminal device 30, the ad request processing unit 120 writes the advertiser's name, address, and advertisement into the ad database 181. The ad request processing unit 120 also writes the advertiser charging items and the ad selecting items (i.e., the display information, content ID, age group, target region, and preference) indicated by the placement request into the ad property table 182, and issues an advertiser ID and an advertisement ID to the advertiser terminal device 30 (step S4). The ad request processing unit 120 then determines the basic fee in accordance with the advertiser charging items designated by the advertiser.

In more detail, the advertiser may designate contents of the ad placement request se follows. For the display information (i.e., the item of display position/size/form) for the advertisement, the display position may be designated as one of center, top, bottom, left, and right relative to the position of the content. The display size may be designated as one of large, medium, and small, and the display form as one of a window and a banner. One or more content IDs may be designated, and one or more age groups may be designated as “elementary school and younger”, “junior high school”, “high school”, “college and elder”, and “elderly”, for instance. One or more target regions may be designated by referring to one or more towns, villages, cities, and prefectures, or the whole country.

When access from the viewer terminal device 20 is detected, the ad selecting unit 131 in the content distributing device 10 sends the content list containing content names and content IDs that are arranged in accordance with types of the contents (step S5).

On receiving a content distribution request from the viewer terminal device 20 that has received the content list (step S6), the ad selecting unit 131 selects an advertisement out of a plurality of advertisements stored in the ad database 181 in accordance with the received content distribution request. The content distributing unit 132 then multiplexes the selected advertisement in the requested content, and sends the ad-multiplexed content to the viewer terminal device 20 (step S7).

The charging unit 133 in the content distributing unit 10 charges the member viewer a predetermined fee for the content (step S8), and also charges the advertiser in accordance with a predetermined fee (step S9).

The stated basic fee based on the combination of advertiser charging items designated by the advertiser may be calculated with the following example calculation method.

The ad request processing unit 120 calculates the basic fee by using a charging factor table (not shown in any figures) stored in the ad information unit 180 as follows. The ad request processing unit 120 specifies charging factors “fa1”, “fa2”, “fa3”, “fa4”, “fa5” and “fa6”, and a maximum basic fee “Ma” (¥/month) to calculate a monthly basic fee “M01.” Here, the charging factors “fa1”˜“fa6” are determined based on the advertiser charging items indicated by each ad placement request, and consist of the following items: the display position of the advertisement as “fa1”; the display size as “fa2”; the display form as “fa3”; the number of content IDs as “fa4”; the number of ages included in the age group as “fa5”; and the number of cities included in the target region as “fa6.” The monthly basic fee “M01” can be calculated using expressions below.

M01=fa1*fa2*fa3*fa4*fa5*fa6*Ma

(0<“fa1”, “fa2”, “fa3”, “fa4”, “fa5”, “fa6”≦1)

For instance, fa1=1.0 is set when the display position is designated as center, and fa1=0.5 is set when the display position is either below, top, right, or left. When the display size is large, medium, and small, “fa2” is set as “1.0”, “0.7”, and “0.5”, respectively. When the display form is designated as a window and a banner, “fa3” is set as “1.0” and “0.7”, respectively. When the number of designated content IDs is “1”, “2 to 9”, . . . and “10 to 100”, “fa4” is set as “0.1”, “0.2”, and “0.3”, respectively. If all the content IDs are designated by the advertiser, fa4=1.0 is set. When the number of ages included in the designated target age is “1”, “2 to 5”, . . . and “100 or more”, “fa5” is set as “0.2”, “0.3”, and “1.0”, respectively. Regarding the target region, “fa6” is set as a ratio of “the number of cities included in the designated target region” to “the total number of cities within the country.” (When the advertiser designates a town or a village, it is regarded as a city.) The maximum monthly basic fee “Ma” may be set as ¥1 million, for instance.

With the above calculation method, an advertisement displayed nearer the center requires a higher fee, and a larger advertisement requires a higher fee. The calculated monthly basic fee “M01” never exceeds the maximum monthly basic fee “Ma.”

As has been described, the content distributing device 10 of the present embodiment receives a content distribution request from the viewer terminal device 20, and selects, from the ad database 181, one or more advertisements that satisfy advertiser's designation in accordance with a content ID and a member ID in the content distribution request. The content distributing device 10 then sends the selected advertisements with the content to the viewer terminal device 20. This system prevents the same advertisement from being indiscriminately distributed to all the viewers, and therefore achieves highly effective advertisement distribution.

With the above content distributing system, each advertiser is charged for advertisements to be distributed according to conditions set by the advertiser, that is, distributed only to viewers regarded by the advertiser to be the most prospective. This allows the content distribution center to set an advertisement fee that is reasonable for the advertisers.

In the above embodiment, the member viewer terminal devices 20 are achieved by PCs. However, they man be achieved by such devices as workstations, portable phones, personal digital assistances (PDAs) that are capable of reproducing and displaying ad-added contents.

In the above embodiment, a content distribution request contains a content ID and a member ID. However, the content distribution request may contain only one of them, or do not have to specify a name of a content or a content. Alternatively, the content distribution request may consist of age, gender, address, and pastime of a member viewer.

In the above embodiment, the data unit 150 is provided within the content distributing device 10. However, the data unit 150 may be provided on the Internet or a local storage outside the content distributing device 10. When the data unit 150 is provided on the Internet, the processing unit 100 of the content distributing device 10 may manage address information (such as URLs (Uniform Resource Locators)) on data stored in the data unit 150 and obtain data in the data unit 150 via the network when necessary. The content distributing device 10 may be dedicated to distribution of advertisements with other devices distributing contents, although the above embodiment describes the content distributing device 10 distributing both contents and advertisements.

The above embodiment describes the four ad selecting items consisting of content ID, age group, target region, and preference. However, the ad selecting items may consist of at least one of the above four items. For instance, when a member viewer requests a content of the sport type, an advertisement for sporting goods or sport game tickets is selected to be distributed. When a member viewer requests a content that targets schoolchildren and children younger than schoolchildren, an advertisement for children's clothing or toys is selected. This can still ensure that advertiser's intention is reflected in selection of advertisements to be distributed.

It is also possible to use a time at which a member viewer makes a content distribution request as the ad selecting item. With this method, an advertisement that is related to housework and targets housewives may be selected during the daytime on workdays, and an advertisement for medical supplies or travels targeting the whole family may be selected after the evening. Using not only the time but also culture and lifestyle of each region as the ad selecting items would achieve more effective ad selection.

The advertiser charging items described in the above embodiment are four items consisting of display position/size/form, age group, target region, and preference. However, the advertiser charging items may be at least one of these four items. In the above embodiment, a display position, a display size, and a display form are handled as a single set of information. However, it is alternatively possible to handle only one or two of them as a single set of information.

In the above embodiment, a content fee is determined regardless of the content's type or popularity, whether the content is for a new work or an old work, or a time at which the content is requested. However, these factors may be used for determining the content fee. For instance, a content with a content type of film may require a higher fee than a content with a type of weather forecast. A content requested by a viewer the higher number of times, or a content for a newer work may require a higher content fee. A content requested during and after evening hours on weekdays may require a higher fee than a content requested at noon on weekdays.

The preference item in the ad property table 182 is not included in the advertiser charging items in the above embodiment. However, the preference item may be also used as one of the ad charging items so that a higher fee is charged to an advertiser when an advertisement for sporting goods, for instance, is distributed to a viewer whose pastime is registered as sport.

In the above embodiment, no ceiling is set on ad fees charged to advertisers. However, such ceiling on ad fees may be provided if the advertisers wish. This is realized by deleting or temporarily removing advertisements and related information from the ad database 181 and the ad property table 182 when fees for advertisements reach the predetermined ceiling.

In this way, advertisers' intention can be also reflected in charging process, and therefore the cost-effectiveness in advertisement distribution can be increased.

What is claimed is:

1. An advertisement distributing device that distributes an advertisement and a content via a communication network to a terminal device used by a user who makes a request for distribution of the content, the advertisement distributing device comprising:
an advertisement storing unit operable to store a plurality of advertisements;
an advertisement selecting unit operable to select at least one advertisement from the plurality of advertisements in the advertisement storing unit in accordance with the request; and
a distributing unit operable to distribute the at least one selected advertisement together with the requested content to the terminal device.

2. The advertisement distributing device of claim 1,
wherein the advertisement selecting unit selects the advertisement in accordance with a content ID (identification) of the requested content.

3. The advertisement distributing device of claim 1, wherein the advertisement selecting unit selects the advertisement in accordance with a property of the user who has made the request.

4. The advertisement distributing device of claim 3, wherein the property of the user is at least one of an age and an address of the user.

5. The advertisement distributing device of claim 3, wherein the property is a preference of the user in content types.

6. The advertisement distributing device of claim 5, wherein the preference is a content type that is determined based on at least one content requested so far by the user.

7. The advertisement distributing device of claim 1, wherein the advertisement selecting unit selects the advertisement in accordance with a time at which the request has been received.

8. The advertisement distributing device of claim 1, further comprising:
an advertisement information storing unit operable to store advertisement information consisting of (a) advertisement IDs of the advertisements stored in the advertisement storing unit and (b) content IDs of contents to which the advertisements should be added, wherein each advertisement ID is associated with at least one of the content IDs; and
a content ID specifying unit operable to specify a content ID of the requested content,
wherein the advertisement selecting unit refers to the stored advertisement information to find an advertisement ID associated with the specified content ID, and selects the advertisement identified by the found advertisement ID.

9. The advertisement distributing device of claim 1, further comprising:
a user information storing unit operable to store user information consisting of (a) user IDs of users and (b) a preference of each of the users in content types, wherein each user ID is associated with a preference;
an advertisement information storing unit operable to store advertisement information that consists of (a) advertisement IDs of the advertisements stored in the advertisement storing unit and (b) an age, an address, and a preference of target users for each of the stored advertisements, wherein each advertisement ID is associated with an age, an address and a preference of target users for an advertisement identified by the advertisement ID; and
a user ID specifying unit operable to specify a user ID of the user when the request is received,
wherein the advertisement selecting unit (a) refers to the user information to find an age, an address, and a preference associated with the specified user ID, (b) refers to the advertisement information to find an advertisement ID associated with the found age, address, and preference, and (c) selects the advertisement identified by the found advertisement ID.

10. A method for distributing an advertisement and a content via a communication network to a terminal device used by a user who makes a request for distribution of a content, the method including:
an advertisement selecting step for selecting at least one advertisement from a plurality of advertisements in accordance with the request; and
a distributing step for distributing the at least one selected advertisement together with the requested content to the terminal device.

11. A program to have a computer function as an advertisement distributing device that distributes a content and an advertisement via a communication network to a terminal device used by a user who makes a request for distribution of the content, the program including:
an advertisement selecting step for selecting at least one advertisement from a plurality of advertisements in accordance with the request; and
a distributing step for distributing the at least one selected advertisement together with the requested content to the terminal device.

12. A terminal device that is used by a user who makes a request to an advertisement distributing device for distribution of a content via a communication network,
wherein the advertisement distributing device comprises:
an advertisement storing unit operable to store a plurality of advertisements;
an advertisement selecting unit operable to receive a content ID of the requested content from the terminal device and to select at least one advertisement from the advertisements in the advertisement storing unit in accordance with the received content ID; and
a distributing unit operable to distribute the at least one selected advertisement together with the requested content to the terminal device, and
wherein the terminal device comprises:
a content ID sending unit operable to send the request containing the content ID; and
a receiving unit operable to receive the advertisement and the content from the advertisement distributing device.

13. A terminal device that is used by a user who makes a request to an advertisement distributing device for distribution of a content via a communication network,
wherein the advertisement distributing device comprises:
an advertisement storing unit operable to store a plurality of advertisements;
an advertisement selecting unit operable to receive a property of the user and select at least one advertisement from the advertisements in the advertisement storing unit in accordance with the received property; and
a distributing unit operable to distribute the at least one selected advertisement together with the requested content to the terminal device,
wherein the terminal device comprises:
a property sending unit operable to send the property to the advertisement distributing device;
a request sending unit operable to send the request to the advertisement distributing device; and
a receiving unit operable to receive the advertisement and the content from the advertisement distributing device.

14. A system that distributes a content and an advertisement via a communication network and comprises a terminal device and an advertisement distributing device, wherein the terminal device is used by a user who makes a request for distribution of the content, and the advertisement distributing device distributes the advertisement to the terminal device, wherein
the terminal device includes:
a content ID sending unit operable to send the request containing a content ID of the requested content; and
a receiving unit operable to receive the advertisement and the content from the advertisement distributing device, and
the advertisement distributing device includes:
an advertisement storing unit operable to store a plurality of advertisements;
an advertisement selecting unit operable to select at least one advertisement from the advertisements in the advertisement storing unit in accordance with the content ID contained in the sent request; and
a distributing unit operable to distribute the at least one selected advertisement together with the requested content to the terminal device.

15. A system that distributes a content and an advertisement via a communication network and comprises a terminal device and an advertisement distributing device, wherein the terminal device is used by a user who makes a request for distribution of the content, and the advertisement distributing device distributes the advertisement to the terminal device, wherein
the terminal device includes:
a property sending unit operable to send a property of the user to the advertisement distributing device;
a request sending unit operable to send the request to the advertisement distributing device; and
a receiving unit operable to receive the advertisement and the content from the advertisement distributing device, and
the advertisement distributing device includes:
an advertisement storing unit operable to store a plurality of advertisements;
an advertisement selecting unit operable to select at least one advertisement from the advertisements in the advertisement storing unit in accordance with the sent property; and
a distributing unit operable to distribute the at least one selected advertisement together with the requested content to the terminal device.

16. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with a content ID (identification) of the requested content; and
a distributing unit operable to distribute the at least one selected advertisement together with the requested content to the terminal device, and
wherein the charging device comprises a determining unit operable to determine the fee for the advertisement placement in accordance with the content ID of the requested content.

17. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with a content ID (identification) of the requested content; and
a distributing unit operable to distribute the at least one selected advertisement together with the requested content to the terminal device, and
wherein the charging device comprises a determining unit operable to determine the fee for the advertisement placement in accordance with a number of times a same content as the requested content has been requested.

18. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with a property of the user who has made the request; and
a distributing unit operable to distribute the at least one selected advertisement together with the requested content to the terminal device, and
wherein the charging device comprises a determining unit operable to determine the fee for the advertisement placement in accordance with the property of the user.

19. The charging device of claim 18, wherein the property of the user is at least one of an age, an address, and a preference in content types of the user.

20. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with a time at which the request is received; and
a distributing unit operable to distribute the at least one selected advertisement together with the requested content to the terminal device, and
wherein the charging device comprises a determining unit operable to determine the fee for the advertisement placement in accordance with the time at which the request is received.

21. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with the request; and
a distributing unit operable to distribute the at least one selected advertisement together with the requested content to the terminal device, and
wherein the charging device comprises a determining unit operable to determine the fee for the advertisement placement in accordance with a size of the advertisement displayed by the terminal device.

22. A charging device that is included in an advertisement distributing device and that determines a fee charged to an advertiser for advertisement placement,
wherein the advertisement distributing device distributes a content and an advertisement via a communication network to a terminal device used by a user who makes a request for distribution of the content, the advertisement distributing device including:
an advertisement storing unit operable to store a plurality of advertisements;
an advertisement selecting unit operable to select at least one advertisement from the plurality of advertisements in the advertisement storing unit in accordance with the request; and a distributing unit operable to distribute the at least one selected advertisement together with the requested content to the terminal device, and
wherein the charging device comprises a determining unit operable to determine the fee for the advertisement placement in accordance with a position of the advertisement displayed by the terminal device.

23. A charging method for an advertisement distributing device to determine a fee charged for advertisement placement to an advertiser, wherein the advertisement distributing device distributes a content and an advertisement via a communication network to a terminal device used by a user who makes a request for distribution of the content, the advertisement distributing device comprising:
an advertisement storing unit operable to store a plurality of advertisements;
an advertisement selecting unit operable to select at least one advertisement from the plurality of advertisements in the advertisement storing unit in accordance with a content ID (identification) of the requested content; and
a distributing unit operable to distribute the at least one selected advertisement together with the requested content to the terminal device,
wherein the charging method includes a step for determining the fee for the advertisement placement in accordance with the content ID of the requested content.

24. A program to have a computer function as a charging device that is included in an advertisement distributing device and that determines a fee charged to an advertiser for advertisement placement, wherein the advertisement distributing device distributes a content and an advertisement via a communication network to a terminal device used by a user who makes a request for distribution of the content, the advertisement distributing device comprising:
an advertisement storing unit operable to store a plurality of advertisements;
an advertisement selecting unit operable to select at least one advertisement from the plurality of advertisements in the advertisement storing unit in accordance with a content ID (identification) of the requested content; and
a distributing unit operable to distribute the at least one selected advertisement together with the requested content to the terminal device, and
wherein the program includes a step for determining the fee for the advertisement placement in accordance with the content ID of the requested content.
